(19) United States
(12) Patent Application Publication
(10) Pub. No.: US 2011/0066518 A1
(43) Pub. Date: Mar. 17, 2011

(54) BID INVALIDATING AUCTION

(76) Inventors: David R. Mack, Newick (GB); Stephen C. P. Mack, Chicago, IL (US)

(21) Appl. No.: 12/561,023

(22) Filed: Sep. 16, 2009

(51) Int. Cl. G06Q 30/00; G06F 19/00

(52) U.S. Cl. 705/26.3; 700/91

(57) ABSTRACT

A bid invalidating auction system may include a memory, an interface, and a processor. The memory stores a plurality of elements characterized by an ordering in which the elements will be rendered ineligible to win a contest. The processor provides, via the interface, the elements to the users, and receives, via the interface, a selection of an element from a user. The processor associates the element with the user if the element is eligible and not associated with another user. The processor renders the next eligible element in the ordering ineligible, if the first element is associated with the first user. The processor repeats the receive, associate, identify and render until an occurrence of an event. Upon the occurrence of the event, the processor identifies the next eligible element in the ordering which is associated with a user and designates the associated user the winner.

### TECHNICAL FIELD

The present description relates generally to a system and method, generally referred to as a system, for providing a bid invalidating auction, and more particularly, but not exclusively, to providing a strategy-based online auction system.

### BACKGROUND

Traditional online auction sites may be losing their luster. The market share of online auction sites may be shrinking amid complaints of fraud and the proliferation of automated bidding software that allows people to win auctions at the last possible moment. Recently a new form of online auction sites has emerged, referred to as “pay-per-bid auctions,” which seek to attract users disillusioned with traditional online auction sites by incorporating an element of entertainment into the auction process. In these types of auctions, users are explicitly or implicitly charged a fee for each bid that they place. There may be two prevalent styles of online pay-per-bid auctions: “penny auctions” and “lowest unique bid” auctions. “Lowest unique bid auctions” may also be referred to as “reverse auctions” or “dutch auctions.”

In penny auctions, a product is offered to users with a starting purchase price of zero which may change over the life of the auction. Users may place a bid to win the right to purchase the item for the purchase price. Each bid placed by a user may increase the purchase price of the product by a small amount relative to the cost of the bid. The increase in the purchase price is often one penny, hence the name “penny auctions”; however, auctions may be shifting towards larger increases in the purchase price. The auction may continue until a countdown timer reaches zero, at which time the user who placed the last bid wins the right to purchase the product at the ending purchase price. The purchase price may often be significantly less than the current market price of the product. If a bidder places a bid in the last few seconds of the auction, for example the last fifteen seconds of the auction, additional time may be added to the countdown timer, such as an additional five seconds. Time may be added to the countdown timer for each bid placed within the last few seconds until no users bid in the last few seconds and the countdown timer reaches zero. The auction may also have a finite end point, but it may often be several weeks away. Penny auctions prevent users from being able to win an auction by bidding in the last few seconds by adding time to the countdown timer when users bid at the end of the auction.

There may be several variants of penny auctions, such as a fixed price auction, where the highest bidder is awarded the right to purchase an item at a fixed price, regardless of the level of bidding. The fixed price may often be significantly lower than the market price of the product. Another variant of penny auctions may be the 100% off auction, where the purchase price is fixed at zero and therefore users only pay for their bids. In a closed penny auction, the auction site chooses a time to close the auction to outside bidders. When the auction is closed only users who have already placed bids can continue to place bids. A last variant of penny auctions is bids back penny auctions, where the winner of the auction does not pay for their bids, but only the final purchase price of the item.

In lowest unique bid auctions, users place bids on a product at any price point they choose. The bids may be in whole pennies or cents. The users may be provided with pricing information, such as the last auction price of the product and the current market price of the product. The auction may take place over a set time interval, such as several days or more. When the time interval expires, the user with the lowest unique bid wins the item for the unique bid price. There may be a minimum number of bids which must be placed before the auction is deemed valid. If the minimum number of bids is not placed within the time interval the auction is cancelled and the users receive their bid money back. The auctions may have a limit on the number of bids they will accept per product in order to increase the bidders' chances of winning.

There may be several variants of the lowest unique bid auction, such as the additional information given auction where users are given additional information about the auction after they place a bid. For example, the users may be informed of whether their bid is the lowest unique bid at that moment in time, whether the bid is unique but not the lowest, or whether the bid is not unique. Another variant may be a bid limited auction where the auction ends after a predetermined number of bids are received, which may increase each bidder's chance of winning the auction.

### SUMMARY

A bid invalidating auction system may include a memory, an interface, and a processor. The memory may be operative to store a plurality of elements characterized by an ordering in which the elements will be rendered ineligible to win a contest, such as an auction, or a game. Each element may initially be eligible to win the auction and unassociated with any user. In one embodiment each element may be associated with a status indicating whether the element is eligible and/or a status indicating whether the element is associated with a user. The memory may also store an indication of an item being auctioned or otherwise offered for sale under the disclosed system. In one embodiment, each of the elements may be further associated with a discrete value or other unique identifier of which the ordering may or may not be based on. The elements may be stored in a data structure such as a database table, an array, or a linked list, and may be visually represented as blocks, shapes, icons, alphanumeric characters, images, or generally any displayable element. The elements may be continuous or may be discrete. The interface is operative to provide, e.g. display, the plurality of elements and an indication of whether each element is eligible to win the auction and whether each element is associated with a user. In one embodiment, the interface may also provide, e.g. display, an indication of the item being auctioned. The interface may receive a selection of a first element from a first user. The processor is operative to associate the first user with the first element if the first element is not associated with another user and the first element is eligible to win the auction. The processor then identifies a second element eligible to win the auction, where the second element, in accordance of the ordering, would be rendered ineligible to win the auction prior to any other eligible element. The processor renders the second element ineligible to win the auction, if the first element is associated with the first user. Rendering an element ineligible to win the auction may also be referred to as invalidating the element. The processor and interface repeat the receive, associate, identify, and render until the occurrence of an event. The event may be all of the elements being associated with a user or rendered ineligible, the expiration of a countdown timer, an arbitrary event, or some other event. Upon the occurrence of the event, the processor identifies a third element which is associated with a second user and eligible to win the auction, where the third element, in accordance with the ordering, would, but for the occurrence of the event, eventually be rendered ineligible to win the auction prior to any other eligible element associated with a user. The processor is operative to designate the second user the winner of the auction.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a bid invaliding auction system.

FIG. 2 is block diagram of a network environment implementing the system of FIG. 1 or other bid invalidating auction systems.

FIG. 3 is a block diagram illustrating a top-down ordering in the systems of FIG. 1 and FIG. 2, or other bid invalidating auction systems.

FIG. 4 is a flowchart illustrating the operations of rendering elements ineligible in the systems of FIG. 1 and FIG. 2, or other bid invalidating auction systems.

FIG. 5 is a flowchart illustrating the operations of a bid invalidating auction in the systems of FIG. 1 and FIG. 2, or other bid invalidating auction systems.

FIG. 6 is a flowchart illustrating the operations of a time limited bid invalidating auction in the systems of FIG. 1 and FIG. 2, or other bid invalidating auction systems.

FIG. 7 is a screenshot of an interface for participating in a bid invalidating auction at the start of the auction in the systems of FIG. 1 and FIG. 2, or other bid invalidating auction systems.

FIG. 8 is a screenshot of an interface for participating in a bid invalidating auction where an auction is in progress in the systems of FIG. 1 and FIG. 2, or other bid invalidating auction systems.

FIG. 9 is an illustration of a general computer system that may be used in the systems of FIG. 2, or other bid invalidating auction systems.

### DETAILED DESCRIPTION

The disclosed embodiments relate to a bid invalidating auction system, and more particularly, but not exclusively, to a strategy based auction system. For illustrative purposes the principles described herein may be referenced in the specific embodiment of an online auction system; however the principles may be embodied in many different forms, e.g. a physical auction, a physical multiplayer game, such as a board game, or an electronic multiplayer, or single player, game played on electronic devices, such as a computer or a mobile phone, or a contest of any form.

In one embodiment, the bid invalidating auction system provides users with an entertaining and engaging alternative to traditional auction systems in the form of a bid invalidating auction system. The system provides users with elements characterized by an ordering in which the elements will be rendered ineligible to win the auction. In one embodiment, the elements may be blocks representing every possible bid value for an item in an auction, and the blocks may be characterized by an ordering based on the bid values. The ordering may include any predictable ordering by which the elements may be rendered ineligible, such as a linear ordering, non-linear ordering, arbitrary ordering or combination thereof, such that the user may predict or otherwise compute which element may be rendered ineligible next prior to their selection of an element. The ordering may allow the user to predict or otherwise compute only the next element to be rendered ineligible, or the ordering may allow the user to predict or otherwise computer the order in which any number of the remaining elements will be rendered ineligible, including the order in which all of the remaining elements will be rendered ineligible. It will be appreciated that more than one ordering may be used by the system. The ordering of the elements may be independent of, or alternatively based on, the bid value or bid amount placed by the user, the cost to place the bid, the value or price of the item to be auctioned, or combinations thereof. The users may select one or more elements; however, in one embodiment, each element can only be selected by one user. The users may be charged a nominal fee for each element they select. While the elements may be characterized by an ordering, the users may select elements in any order, i.e. in the embodiment utilizing a linear ordering, elements “lower” in the linear ordering do not have to be selected before elements “higher” in the linear ordering, and elements “lower” in the linear ordering can still be selected after elements “higher” in the linear ordering have been selected. Each time a user selects an element, the system renders at least one element ineligible to win the auction in accordance with the ordering, regardless of whether that user or another user has selected the element being rendered ineligible. For example, the system may render ineligible the eligible element which, in accordance with the ordering, would be rendered ineligible prior to any other eligible elements. In one embodiment, the system may render one element ineligible for every two elements selected, every three elements selected, or any number of elements selected. For example, each time a user selects an element, where each element is characterized by a bid value and the elements are ordered linearly based on their bid values, the system may render ineligible the eligible element having the highest bid value. Once an element is rendered ineligible, the element can no longer win the auction and the element can no longer be selected by the users. Thus, over the course of the auction, the elements will be consumed, i.e. selected by the users and/or rendered ineligible by the system, until all of the elements have been either selected and/or rendered ineligible, or alternatively, until a time limit for the auction elapses or another auction ending event occurs or condition is met. After all of the elements have been selected and/or rendered ineligible, or the auction is otherwise concluded, the system identifies the winning element as the eligible user selected element which would, but for the end of the auction, eventually be rendered ineligible prior to any other eligible user selected element. The winning user may then be allowed to purchase the item for a value below the manufacturer's suggested retail price (MSRP) of the item. In one embodiment, the user may be allowed to purchase the item for the bid value represented by the winning element, or for some other discounted value.

In one embodiment, the bid invalidating auction system may include any number of elements for bidding on an item for auction. The elements may be characterized by an invalidation order and each individual element may further be characterized by a bid value, and a cost per bid. The bid value may vary for each element and may be any positive or negative value. In the case of a negative value, the user placing the bid may receive value, such as money, for purchasing an item. For example, the bid value of an element may be negative in order to sell an item for less than the cost per bid. The bid value for each element may remain constant for the entire auction, or the bid value for each element may vary throughout the auction, such as upon the occurrence of an event. Likewise the cost per bid may vary for each element and may be any positive or negative value. In the case of a negative cost per bid, a user may receive value, such as money, for placing a bid. For example, the cost per bid of an element may be a negative value to encourage users to place a bid which, in turn, may invalidate another user's bid and entice the user whose bid was invalidated to place another bid which may have a higher cost per bid associated with it. The cost per bid for each element may remain constant throughout the auction or the cost per bid may vary throughout the auction on a per element and/or a per user basis. For example, the cost per bid may increase or decrease with each bid placed, upon the expiration of a time interval, as the end of the auction approaches, or generally upon the occurrence of any event related to the item or the auction. The elements may be displayed to the users in a linear order, such as ordered by the bid values from lowest to highest, ordered by bid values from highest to lowest, or the elements may be displayed in a non-linear order, a random order, an arbitrary order or the elements may be displayed without any order.

The system may also include a timer, or other mechanism for ensuring the auction does not continue indefinitely. In the case of a timer, the auction ends when the timer expires or when all of the elements are either selected or rendered ineligible, whichever occurs first. The system may add an incremental amount of time to the timer each time an element is selected by a user. The amount of time added to the timer may be fixed or variable and may be based on the amount of elements available such that the amount of time added increases as the number of elements available decreases. In one embodiment, the time may only be added when elements are selected during a certain time window proximate to the end of the auction, such as when elements are selected in the last five minutes of the auction. Alternatively, the system may automatically start rendering elements ineligible to win the auction after a determined amount of time expires from the start of the auction. The automatic rendering of elements ineligible may subside when another element is selected by a user. Lastly, the fee charged to the users for selecting an element may be fixed or variable and may increase as the time remaining in the auction decreases.

The system may be used to play a multiplayer game. For example, a set of blocks are provided to users where the blocks are characterized by an ordering by which the blocks will be removed from the game. The users can purchase one or more blocks for a nominal fee; however, each block can only be purchased by one user. Each time a user purchases a block, at least one block is removed from the game in accordance with the ordering, regardless of whether a user has selected the block. In one embodiment, the ordering may consist of removing the block having the highest order in a linear ordering. Once a block is removed from the game, the block can no longer win the game and can no longer be purchased by a user. The game continues until all of the blocks have been either purchased by the users or removed from the game. The user who purchased the block which would, but for the end of the game, eventually be rendered ineligible prior to any other remaining user selected blocks is designated the winner. The winning user may be awarded a prize, such as a monetary prize. The monetary prize may be a percentage of the nominal fees collected from the users.

The system may provide a user interface to the users for participating in the bid invalidating auction. The user interface displays the elements in a displayable form, such as blocks, to the users for a particular item being auctioned. In one embodiment, a bid value associated with each block and/or the cost of selecting each block may be displayed with each block. A graphical attribute of the blocks is modified in order to differentiate the different states of the blocks, such as blocks which are eligible and unassociated with a user, blocks which are eligible and associated with the current user, blocks which are eligible and associated with other users, and blocks which are ineligible. For example, the color of the blocks may be modified based on the state of the block. In one embodiment, the user interface may display the bid value of the selected eligible block having the current highest bid value. The user interface may also flash the next selected block to be rendered ineligible in accordance with the ordering, i.e. the block which would be the winning block if the auction were to end at that time. The user interface may provide the user with audible indications of the status of the auction. For example, the user interface may provide an audible indication when the auction is close to ending, when the user has the current winning block, when a block of the user is rendered ineligible, when a block of the user is surpassed by another user, or generally when any other event occurs which may be of interest to a user.

The system allows an organization to determine a minimum bid value, a maximum bid value, i.e. the bid value being the amount the winning user would pay for the auctioned item if the associated element is determined to be the winner, a bid increment, i.e. incremental difference in the bid values of consecutive elements, or otherwise determine the number elements which will be made available during the auction, and a cost per bid, i.e. the price paid by the user for selecting an element, for an item. The minimum bid value, maximum bid value, bid increment and cost per bid may be determined such that a single user, or a group of collaborating users, cannot guarantee themselves a win of the item at a collective cost, i.e. the sum of the bid value of the winning element, if any, plus the cost of all of the selected elements, below the market price, or manufacturer's suggested retail price (“MSRP”) of the item, by simply dominating the auction, such as by selecting a predetermined number of available elements. The cost per bid, minimum bid value, maximum bid value and/or bid increment may be determined based on MSRP of the item and the number of bids available to the users. Alternatively, the number of bids may be determined based on the minimum bid value, the maximum bid value and the bid increment. In one embodiment, the cost per bid may vary, in fixed or dynamic manner, for each element and each user, such as to discourage the consecutive selection of sequential elements in the ordering. For example, if a user selects an element, the cost of a subsequent bid on a sequential element in the ordering may increase for that particular user. However, the cost to bid on the element may not increase for users who have not bid on a sequential element. Alternatively, when a user selects an element, the cost of selecting a sequential element may increase for all of the users. The cost per bid may increase depending on the number of the sequential elements selected, such that the more sequential elements that are purchased the more expensive the remaining sequential elements become. In one embodiment the cost per bid may vary based on a determined probability of the associated element winning the auction. For example, the middle third of the elements may be the most likely to win the auction and thus may be the most expensive, while the first and last thirds of the elements may be less likely to win the auction and therefore may be less expensive. In one embodiment, an organization may provide the MSRP of an item, the minimum bid value, the maximum bid value, and the bid increment, and the system may generate a cost per bid such that a bid invalidating auction for the item will be attractive to bidders while ensuring no single user, or group of collaborating users, can guarantee themselves a win of the auction at a collective cost below the MSRP of the item. In one embodiment, the minimum bid value may be set to zero if the organization wishes to sell the item for the cost per bid. Determining the cost per bid for an item is discussed in more detail below.

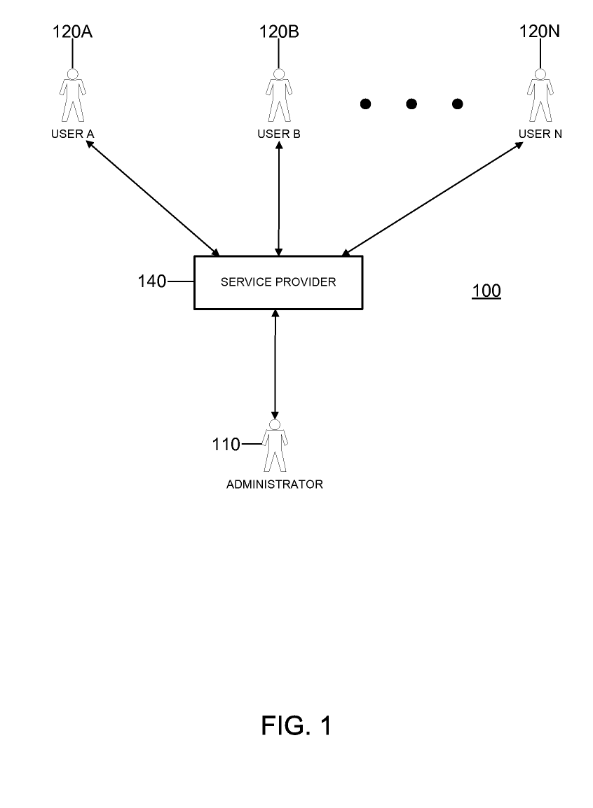

FIG. 1 provides a general overview of a bid invalidating auction system. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more users 120A-N, an administrator 110, and a service provider 140. The users 120A-N may be one or more participants in an auction, game, or contest provided by the service provider 140. Alternatively, the users 120A-N may be computing devices configured by persons interested in participating in an auction, game, or contest provided by the service provider 140. The service provider 140 may provide the users 120A-N with a bid invalidating auction system, or block invalidating game, which allows the users 120A-N to engage in an entertaining and strategy based auction system. The users 120A-N may be able to purchase items at prices significantly below the current market prices for the items through the bid invalidating auction system. The administrator 110 may be a computing device or person responsible for configuring the auction system offered by the service provider 140.

In one embodiment, elements provided to the users 120A-N, such as blocks, may be characterized by an ordering by which the elements will be rendered ineligible to win the auction. The ordering may be a linear ordering, non-linear ordering, arbitrary ordering or combination thereof, such that the user may predict or otherwise compute which element may be rendered ineligible next prior to their selection of an element. The elements may or may not be associated with particular bid values for the auction. Although the elements may not be associated with particular bid values, the element next to be rendered ineligible in accordance with the ordering may be considered as having the highest bid value and the element last to be rendered ineligible in accordance with the ordering may be considered as having the lowest bid value, the terms “highest” and “lowest” being used as a matter of convenience in discussing the order of rendering elements ineligible and designating a winner, but otherwise being implementation dependent. In another embodiment, a minimum bid value, maximum bid value, a bid increment, and a cost per bid are determined by the service provider 140 for an item to be auctioned. Each bid increment from the minimum bid value to the maximum bid value is represented by an element. Thus, there will be an element representing every possible bid value in the auction for the item, ranging from the minimum bid value to the maximum bid value

The service provider 140 may provide the elements to the users, such as through a web page. The users 120A-N may select one or more elements to purchase for the cost per bid; however each element can only be purchased once, i.e. no element can be owned by more than one of the users 120A-N. Selecting an element may be akin to placing a bid in a traditional auction system, where the bid amount is the value associated with the selected element. However, unlike traditional auction systems, the users 120A-N may select elements in any order. Thus, in an embodiment where the elements are ordered linearly based on bid values, the users 120A-N may select elements having higher bid values before all of the elements having lower bid values have been selected, and the users 120A-N may select elements having bid values lower than the selected elements having the highest bid value. Thus, the elements may be selected arbitrarily including non-linearly. The users 120A-N may also place multiple bids simultaneously, such as by selecting a contiguous set of elements. By allowing the users 120A-N to select elements arbitrarily, the auction system reduces the desirability of submitting a bid at the end of the auction, as a desired element may have previously been selected by another user.

In one embodiment, each time one of the users 120A-N selects an element, a least one eligible element is rendered ineligible in accordance with the ordering. Alternatively, at least one eligible element may be rendered ineligible for every two elements selected, every three elements selected, or generally for any number of elements selected. In one embodiment, each time one of the users 120A-N selects an element, the eligible element having the highest bid value may be rendered ineligible. Alternatively, the eligible element having the lowest bid value may be rendered ineligible. The ordering in which the elements will be rendered ineligible may be provided to the users 120A-N such that the users 120A-N can develop bid selection strategies for winning the auction.

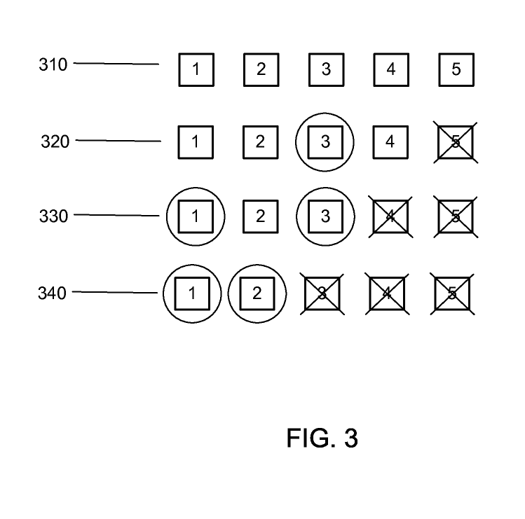

In another embodiment, each time a user A 120A purchases an element, the maximum bid value of the auction decreases. Any elements having bid values above the new maximum bid value are deemed ineligible and are no longer part of the auction, regardless of whether any of the users 120A-N had purchased the elements. An ordering in which the highest valued eligible elements are rendered ineligible, referred to as a “top-down” ordering, is discussed in more detail in FIG. 3 below.

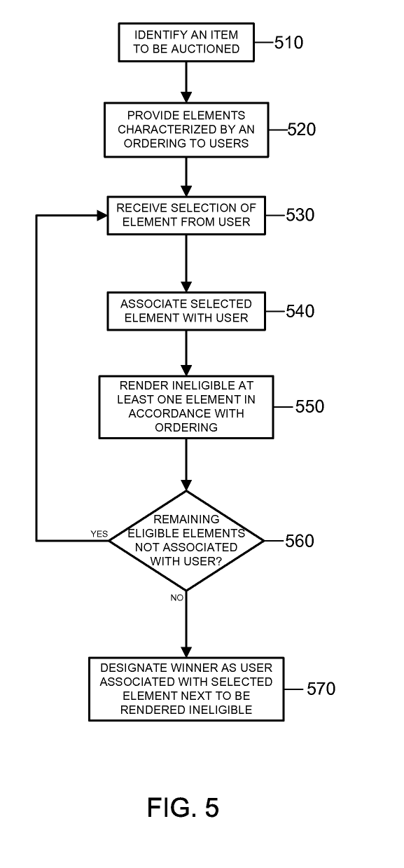

The auction continues until each of the elements have been exhausted, i.e. each element has either been selected by one of the users 120A-N and/or rendered ineligible, or some other event occurs or condition is met, such as a characteristic associated with item changes, an arbitrary event occurs, or an external variable related the item changes. For example, if the item is tickets to an event, the auction may end, or elements may be automatically rendered ineligible, as the date of the event approaches. Alternatively, if there are multiple items being auctioned and the inventory of the items drops below a certain level the auction may end. At the end of the auction, the winning element is identified as the eligible user selected element which would, but for the end of the auction, eventually be rendered ineligible prior to any other eligible user selected element. The user who selected the winning element is designated the winner of the auction. The winning user A 120A can purchase the item being auctioned for the winning bid value or some other value, such as a discounted retail price. Since there are a limited number of elements, there is an inherent limit on the number of bids that can be placed by the users 120A-N and any one user A 120A. The bid invalidating auction process is discussed in more detail in FIG. 5 below.

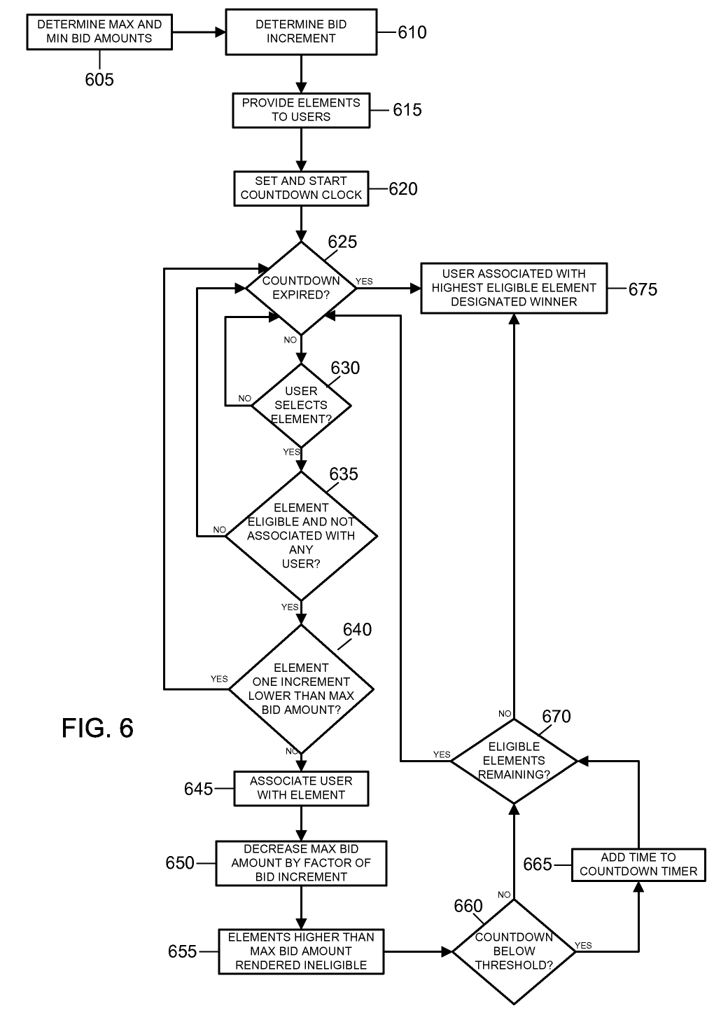

Alternatively or in addition, each auction may be associated with a time interval. In this example, the auction ends when all of the elements have been purchased or rendered ineligible, or when the time interval expires. If a user A 120A selects an element within a margin of time, either fixed or variable, of when the time interval is about to expire, such as within fifteen seconds of the expiration of the time interval, an additional amount of time, either fixed or variable, may be added to the time interval. The additional amount of time may be small, such as five seconds; however, the additional amount of time may be set so as to allow for the other users 120B-N to respond to the element selected by the user A 120A. The time-limited bid invalidating auction system is discussed in more detail in FIG. 6 below.

In an embodiment where the maximum bid value decreases with each bid placed, the linear relationship between purchasing elements and the maximum bid value decreasing introduces strategy into the auction process by allowing the users 120A-N to directly influence the outcome of each auction. For example, a user A 120A may render ineligible a higher value element of a user B 120B by purchasing additional elements, including elements which are unlikely to win the auction, until the maximum bid value is below the element of the user B 120B, thereby rendering ineligible the element of the user B 120B. Alternatively, the user A 120A could purchase an element of a higher value than that of the user B 120B. Thus, the result that the highest valued elements will be rendered ineligible may encourage the users 120A-N to purchase lower valued elements; however, the need to have the highest remaining element to win encourages purchasing higher valued elements. Attempting to balance these two variables creates an entertaining and strategy based auction for the users 120A-N.

Furthermore, a user A 120A can render ineligible an eligible element, instead of letting a competitor take ownership of the element and then rendering the element ineligible. Rendering unselected elements ineligible may influence the winning element position higher (upwards), while rendering ineligible user selected elements may influence the winning element position lower (downwards).

Generally, the rendering of elements ineligible forces the users 120A-N to strategize on whether to place bids at the beginning of the auction or at the end of the auction. There will often be a greater selection of bid placement at the beginning of the auction, and there will often be contiguous groups of elements available; however, at the beginning of the auction the users 120A-N will have limited knowledge of how the auction will play out. Conversely, at the end of the auction the users 120A-N will have more information on which element is likely to win the auction; however, there may be limited elements available to select at or towards the end of the auction.

In one embodiment, the service provider 140 identifies items to be auctioned and determines the maximum bid value, minimum bid value, and bid increment for each item. The maximum bid value for the item may be significantly below the current market price of the item, thereby making it desirable for the users 120A-N to participate in the auction. The minimum bid value may often be set to zero. The bid increment defines each of the possible bid values for the item, starting at the minimum bid value and running to the maximum bid value, each bid value increasing by the bid increment. The bid increment often may be a small denomination of currency, such as one penny.

The service provider 140 may also determine a fee charged to the users 120A-N for placing a bid in the auction for the item, referred to as a cost per bid. The cost per bid may vary from auction to auction and may depend on whether the elements are associated with bid values where the winning user is required to pay the winning bid value to acquire the item. If the elements are associated with bid values, the cost per bid may be based on the minimum bid value, the bid increment, and the ratio of the MSRP of the item to the maximum bid value. The service provider 140 may determine a cost per bid such that a user A 120A, or a group of collaborating users 120A-N, cannot guarantee a win of the auction at a collective cost below the MSRP of the item. In other words, the service provider 140 may set the cost per bid such that the cumulative fees required to purchase enough elements to guarantee a win of the auction will exceed the MSRP of the item.

For example, assume the elements are associated with bid values, the minimum bid value is zero dollars, the bid increment is ten cents, and the maximum bid amount is one-third of the MSRP. Since a user could purchase the middle third elements to guarantee a win of the auction, the following equation can be derived which describes a balance between the MSRP and the cost of a guaranteed win:

((MSRP/9)×(cost per bid/bid increment))+(MSRP× 2/9)=MSRP.

Working through this equation results in 7×bid increment=cost per bid. Thus, in order to ensure a user cannot guarantee a win of the auction at a cost lower than the MSRP of the item, the cost per bid should be set at seven times the bid increment. Since in the current example the bid increment is ten cents, the cost per bid should be set at seventy cents. Alternatively, if the remaining elements are selected by other users 120B-N, even though they have no chance of winning, then the equation would be derived as:

((MSRP/9)×(cost per bid/bid increment))+(MSRP× 1/9)=MSRP.

Working through this equation results in 8×bid increment=cost per bid. Thus, in this example the cost per bid should be set at eighty cents to ensure a user cannot guarantee a win of the auction at a cost lower than the MSRP of the item. Alternatively, if there are no bid values associated with the elements, then a user A 120 would only have to pay the price of the middle third of the elements to guarantee a win of the auction. Thus, in this example the equation would not include the cost of the winning bid value and would be derived as:

(MSRP/9)×(cost per bid/bid increment)=MSRP.

Working through the equation results in 9×bid increment=cost per bid. Thus, in the current example the cost per bid should be set at ninety cents to ensure a user cannot guarantee a win of the auction at a cost lower than the MSRP of the item.

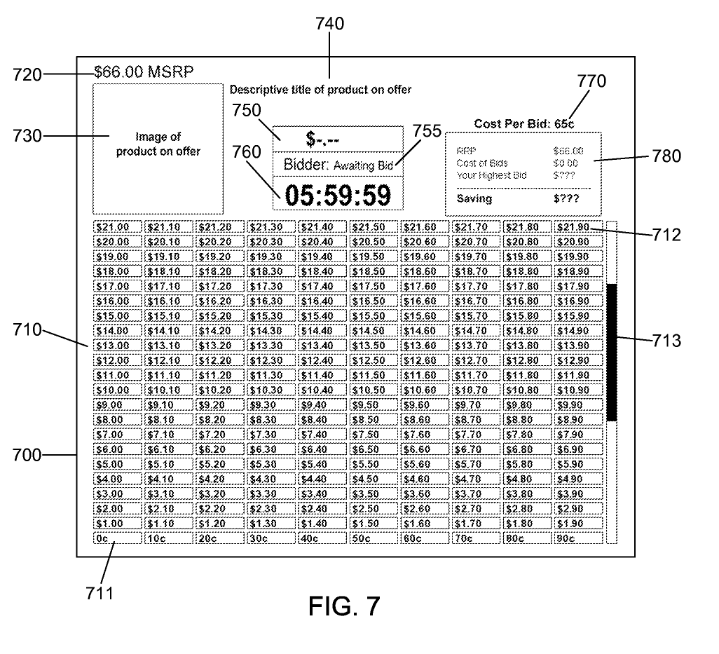

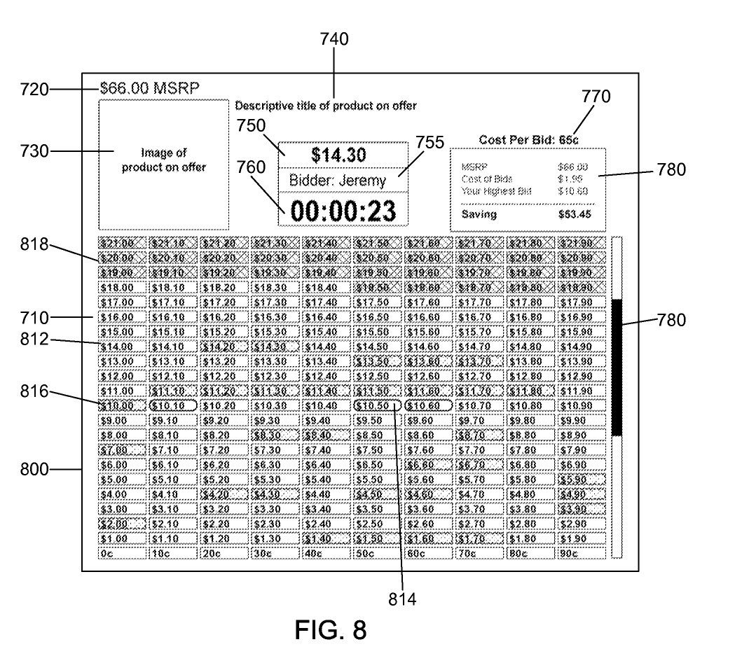

The users 120A-N may access the auctions provided by the service provider 140 through a user interface, such as web browser or any application capable of processing the aforementioned content. The user interface may be provided by the service provider 140 and may be implemented by a computing device with a processor such as a personal computer, personal digital assistant, video game console/device, mobile phone, or any other wired or wireless device capable of implementing a web application. The computing device maybe any device capable of accessing a network, such as the internet. Exemplary user interfaces for participating in a bid invalidating auction system are shown and discussed in more detail in FIGS. 7-8 below. Alternatively, the users 120A-N may use an audio based interface for participating in a bid invalidating auction system, such as through a telephone.

The administrator 110 may maintain a database of the items being auctioned by the service provider 140 and the associated auction information for the items, such as the maximum and minimum bid values, the bid increments, the cost per bid, or generally any other information related to the auction of the item. The administrator 110 may access the auction data through an interface provided by the service provider 140. The interface may be implemented by a computing device with a processor such as a personal computer, personal digital assistant, video game console/device, mobile phone, or any other wired or wireless device capable of implementing a web application. The computing device maybe any device capable of accessing a network, such as the internet.

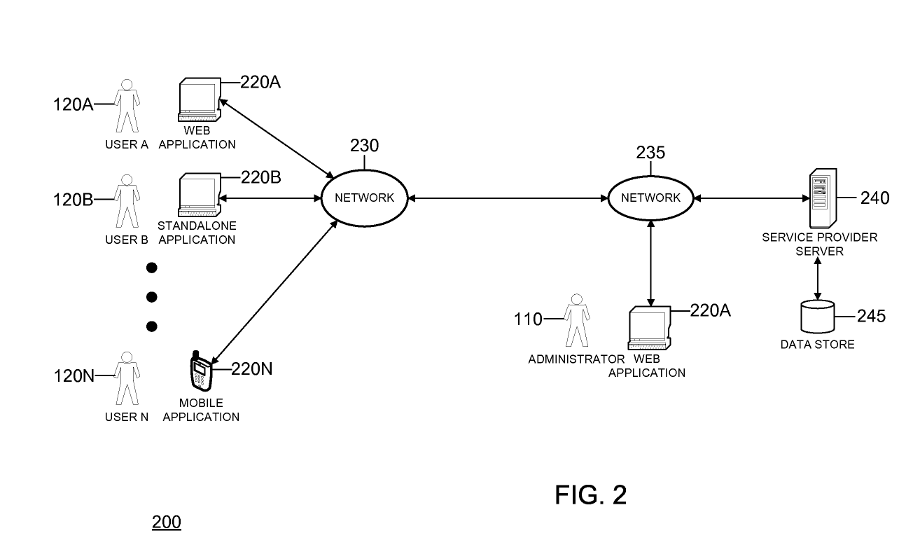

FIG. 2 provides a simplified view of a network environment 200 implementing the system of FIG. 1 or other bid invalidating auction systems. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more web applications, standalone applications, mobile applications which may run on computing devices 220A-N of the users 120A-N and a web application 210, which may run on a computing device 210 of the administrator 110. The network environment 200 may also include a network 230, a network 235, an administrator 110, a service provider server 240, and a data store 245.

The data store 245 may be operative to store data, such as data relating to auctions of items to the users 120A-N. For example, the data store 245 may store the maximum bid value, the minimum bid value, the bid increment and the cost per bid for each item being auctioned. The data store 245 may also store identifying information of the users 120A-N, such as logins, passwords, billing addresses or other any other identifying information of the users 120A-N. The data store may also store the elements provided to the users 120A-N. In one example, the data store may include a table having a row for each element. Each row may have a field identifying the element, a field identifying whether the element is eligible, or partially eligible, and a field identifying one of the users 120A-N associated with the element, if any.

The data store 245 may include one or more relational databases or other data stores that may be managed using various known database management techniques, such as, for example, SQL and object-based techniques. Alternatively or in addition the data store 245 may be implemented using one or more of the magnetic, optical, solid state or tape drives. The data store 245 may be in communication with the service provider server 240.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The administrator 110 may communicate with the service provider server 240 via the network 230. The administrator 110 may use a graphical interface provided by the service provider server 240 to maintain and/or modify information relating to the auctions provided by the service provider server 240. The graphical interface may run on the computing device 210. The service provider server 240 may communicate with the users 120A-N via the networks 230, 235, through the web applications, standalone applications or mobile applications running on the computing devices 220A-N. The users 120A-N may access interfaces for participating in bid invalidating auctions from the service provider server 240 through the computing devices 220A-N.

The computing devices 220A-N may be connected to the networks 230, 235 in any configuration that supports data transfer. This may include a data connection to the network 230 that may be wired or wireless. The computing device 220A running a web application may be on any platform that supports web content, such as a web browser or a computer, a mobile phone, personal digital assistant (PDA), pager, network-enabled television, digital video recorder, such as TIVO®, video game console/device, automobile and/or any appliance or device capable of data communications.

The computing device 220B running the standalone application may be a machine that has a processor, memory, a display, a user interface and a communication interface. The processor may be operatively connected to the memory, display and the interfaces and may perform tasks at the request of the standalone application or the underlying operating system. The memory may be capable of storing data. The display may be operatively connected to the memory and the processor and may be capable of displaying information to the user B 120B. The user interface may be operatively connected to the memory, the processor, and the display and may be capable of interacting with a user B 120B. The communication interface may be operatively connected to the memory, and the processor, and may be capable of communicating through the networks 230, 235 with the content provider servers 210A-N. The standalone application may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, amongst others.

The computing device 220N running a mobile application may be any mobile device that has a data connection. The data connection may be a cellular connection, a wireless data connection, an internet connection, an infra-red connection, a Bluetooth connection, or any other connection capable of transmitting data. For example, the mobile application may be an application running on an iPhone™ available from Apple, Inc.

The service provider server 240 may include one or more of the following: an application server, a data store, such as the data store 245, a database server, a middleware server, and an advertising services server. The service provider server 240 may exist on one machine or may be running in a distributed configuration on one or more machines. The service provider server 240 may be referred to as the server. The service provider server 240 and the content provider servers 210A-N may receive communications from the users 120A-N, such as HTTP requests, and may serve pages to the users 120A-N based on their communications.

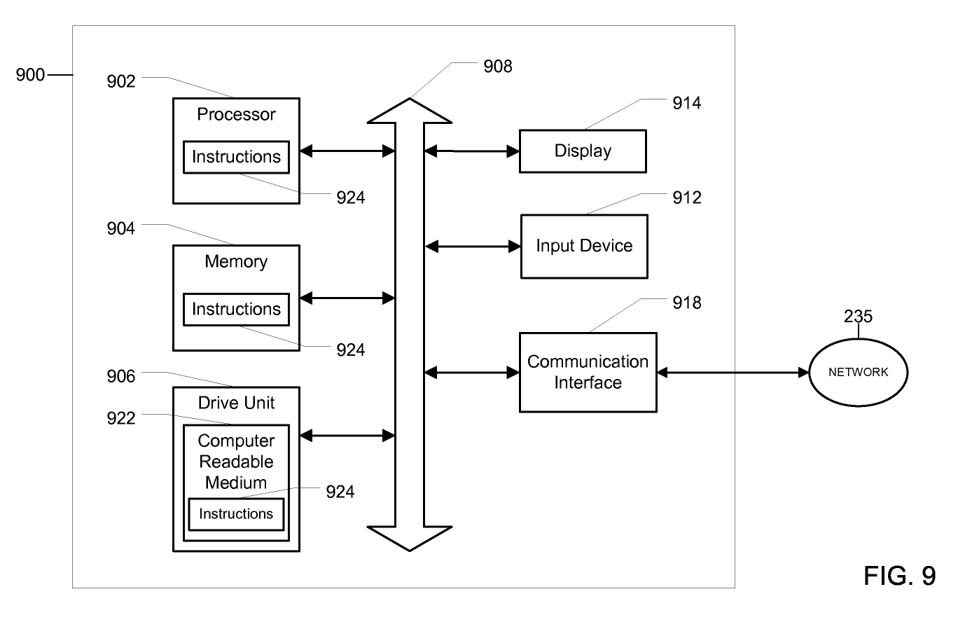

The service provider server 240, the computing devices 220A-N and the computing device 210 may be one or more computing devices of various kinds, such as the computing device described in FIG. 9 below. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite.

There may be several configurations of database servers, such as the data store 245, application servers, middleware servers and advertising services servers included in the service provider server 240. Database servers may include MICROSOFT SQL SERVER®, ORACLE®, IBM DB2® or any other database software, relational or otherwise. The application server may be APACHE TOMCAT®, MICROSOFT IIS®, ADOBE COLDFUSION®, YAPACHE® or any other application server that supports communication protocols. The middleware server may be any middleware that connects software components or applications. The middleware server may be a relevancy engine, a context matching engine, or any other middleware.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In order to prevent automated bidding, the service provider server 240 may restrict the rate of bidding for each of the users 120A-N. For example, the service provider server 240 may only allow a determined number of bids, such as ten, to be placed by each user over a period of time, such as a minute, from each of the computing devices 220A-N. The service provider server 240 may also encrypt the data communicated to the computing devices 220A-N, and the computing devices 220A-N may encrypt the data communicated to the service provider server 240. The service provider server 240 may also monitor the computing devices 220A-N to detect overly accurate movements of a pointing device which may be indicative of automated bidding. The service provider server 240 may also slightly move the interface provided to the computing devices 220A-N, or may slightly change the colors of the interface, such as on a periodic basis, to prevent automated bidding. The service provider server 240 may also set the cost per bid sufficiently high such that it would be economically undesirable for the users 120A-N to use automated bidding. Alternatively, the service provider server 240 may set a variable cost per bid such that purchasing contiguous elements would be economically undesirable for a user or set of users. The cost per bid may be variable on a per user basis or the cost per bid may be uniformly variable for all of the users.

The service provider server 240 may also allocate a determined number of shifts to each auction. A shift allows a user A 120A to shift the current winning element up or down one element at any point before the auction completes. The shift may be purchased by the users 120A-N and/or provided to the users 120A-N for free. The use of shifts prevents any one user A 120A, such as an automated bidding system, from being able to identify a winning element because the winning element could change based on the use of the shifts by the other users 120B-N. Any one user would need to possess all of the shifts to be able to definitively identify the winning element. The service provider server 240 may allocate shifts to an auction such that purchasing all of the shifts, through collaboration, would be excessively expensive and/or difficult.

FIG. 3 is a block diagram illustrating a top-down ordering 300 in the systems of FIG. 1 and FIG. 2, or other bid invalidating auction systems. The top-down ordering 300 may be used in an embodiment where elements are linearly ordered based on an implied or associated value. The top-down ordering 300 describes an ordering where a highest valued eligible element is rendered ineligible. The top-down ordering 300 includes a start state 310, a first selection state 320, a second selection state 330, and an end state 340. Each of the states 310-340 includes five elements, represented by blocks, which are characterized by a linear ordering. The blocks are ordered from left to right such that the right-most block is the highest valued block and the left-most block is the lowest valued block. For explanation purposes, the ordered blocks are displayed with numerical values ranging from the lowest value (one) to the highest value (five). A block that has been selected by one of the users 120A-N is shown with a circle around it, while a block which has been rendered ineligible is shown with an “X” through it.

At the start state 310, none of the blocks have been selected or rendered ineligible Thus, all of the blocks are available for selection by the users 120A-N. Alternatively, the system 100 may prevent the users 120A-N from selecting the block with a value of five, as the block would immediately be rendered ineligible by virtue of being the block with the current highest value. At the first selection state 320, the user A 120A selects the block with a value of three, as indicated by the circle around the block with a value of three. Since a block has been selected, the system 100 renders ineligible the eligible block with the highest value, regardless of whether the block has been selected by one of the users 120A-N. In the first selection state 320, the eligible block with highest value is the block with a value of five. Thus, the block with a value of five is rendered ineligible, as indicated by the “X” through the block. At the end of the first selection state 320, the block with a value of three has been selected by one of the users 120A-N, such as the user A 120A, and the block with a value of five has been rendered ineligible as a result of the selection by the user A 120A. Therefore, the block with a value of three and the block with a value of five are no longer available for selection by the users 120A-N. However, the blocks with a value of one, two and four are available for selection by the users 120A-N. Alternatively, the system 100 may prevent the users 120A-N from selecting the block with a value of four because the block would be immediately rendered ineligible, as explained above. If the auction were to end at the end of the first selection state 320, the user A 120A would be designated the winner because the user A 120A selected the eligible block with the current highest value (three).

At the second selection state 330, one of the users 120A-N, such as the user B 120B, selects the block with a value of one. Since a block has been selected, the system 100 renders ineligible the eligible block with the highest value, regardless of whether the block has been selected by one of the users 120A-N. In the second selection state 330, the eligible block with current highest value is the block with a value of four. Thus, the block with a value of four is rendered ineligible, as indicated by the “X” through the block. At the end of the second selection state 330, the block with values of one and three have been selected by the users 120A-B and the blocks with values of four and five have been rendered ineligible. Therefore, these four blocks are no longer available for selection by the users 120A-N. If the auction ended at the end of the second selection state, the user A 120A would be designated the winner, because the user A 120A selected the eligible block with the current highest value (three).

At the end state 340, one of the users 120A-N, such as the user N 120N, selects the block with a value of two. Since a block has been selected, the system 100 renders ineligible the eligible block with the highest value, regardless of whether the block has been selected by one of the users 120A-N. In the end state 340, the eligible block with the highest value is the block with a value of three. Thus, the block with a value of three is rendered ineligible, even though the block with a value of three was previously selected by the user A 120A. Since all of the blocks have either been selected by the users 120A-N and/or rendered ineligible, the auction is complete. The winning block is the eligible user selected block which would, but for the end of the auction, eventually be rendered ineligible prior to any other eligible user selected block. In the end state 340, the blocks with values of three, four, and five have been rendered ineligible. Thus, the block with a value of two is the winning block because the block with a value of two is the eligible user selected block which would, but for the end of the auction, eventually be rendered ineligible prior to any other eligible user selected block, and the user N 120N is designated the winner for selecting the block with a value of two.

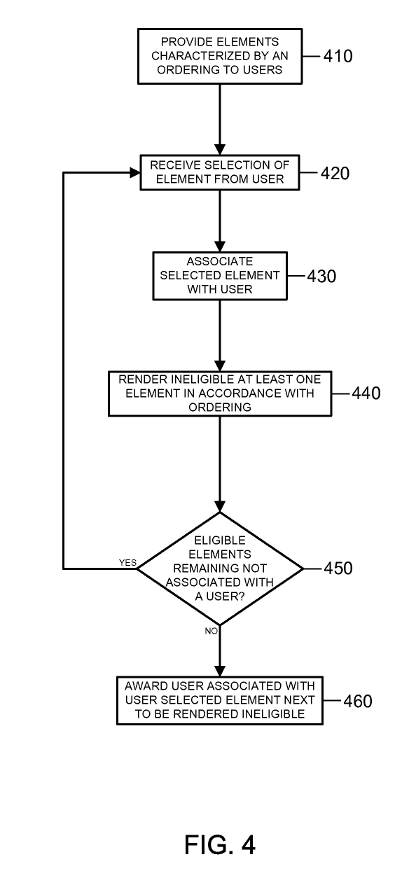

FIG. 4 is a flowchart illustrating the operations of invalidating ordered elements in the systems of FIG. 1 and FIG. 2, or bid invalidating auction systems. The steps of FIG. 4 are described as being performed by the service provider server 240. However, the steps may be performed by the processor of the service provider server 240, or by any other hardware component of the service provider server 240. Alternatively the steps may be performed by an external hardware component.

At step 410, the service provider server 240 provides elements characterized by an ordering to the users 120A-N. The ordering may identify the order in which the elements will be rendered ineligible and may be provided to the users 120A-N such that the users 120A-N can develop element selection strategies for winning the auction. In one embodiment, each element of a set of elements may be associated with a denominated value, such as a numerical value and may be ordered based on the numerical values. The elements may be depicted on a user interface provided to the users 120A-N such as the user interfaces shown and discussed in FIGS. 7-8 below. In one embodiment, the elements may be displayed to the users 120A-N in accordance with the ordering. For example, the rightmost element may be considered as the next element to be rendered ineligible, and the leftmost element may be considered the last element to be rendered ineligible, or vice-versa. Alternatively, the elements may be displayed in order from top to bottom, bottom to top, or any other element display which indicates the order by which the elements will be rendered ineligible.

At step 420, the service provider server 240 may receive a selection of an element from one of the users 120A-N, such as the user A 120A. For example, the user A 120A may use a computer pointing device to select an element displayed in one of the user interfaces shown in FIGS. 7-8 below. The user A 120A may only be allowed to select an element if the element was not previously selected by any of the other users 120B-N and the element is eligible, i.e. the element was not previously rendered ineligible. At step 430, the service provider server 240 may associate the selected element with the user A 120A, such as by adding a data record to the data store 245 indicating that the user A 120A selected the element. The service provider server 240 may debit the account of the user A 120A by a nominal fee if the selected element is associated with the user A 120A. The user A 120A may be required to maintain credit in an account with the service provider 140 in order to participate in the auction. Alternatively, the service provider 140 may track the charges accumulated by the user A 120A and may charge an account of the user A 120A on a periodic basis, such as on a monthly basis.

At step 440, the service provider server 240 may render ineligible at least one element in accordance with the ordering. In one embodiment, the service provider server 240 may render ineligible the eligible element having the highest ordered value. Alternatively, the eligible element having the lowest ordered value may be rendered ineligible, or more than one, or less than one, element may be ineligible for each element selected. At step 450, the service provider server 240 may determine whether any elements remain which are not associated with one of the users 120A-N or have not been rendered ineligible. If, at step 450, the service provider server 240 determines that there are eligible elements which are not associated with one of the users 120A-N, then the service provider server 240 returns to step 420.

If, at step 450, the service provider server 240 determines that all of the elements have been associated with one of the users 120A-N, or have been rendered ineligible, the service provider server 240 moves to step 460. At step 460, the service provider server 240 designates the user associated with the eligible user selected element which would, but for the end of the auction, eventually be rendered ineligible prior to any other eligible user selected element, the winner. The winning user may be awarded a prize, such as a monetary prize. In the case of an online auction, the winning user may be allowed to purchase an item being auctioned for a value below the MSRP of the item, such as the value of the winning element, or some other discounted value.

FIG. 5 is a flowchart illustrating the operations of a bid invalidating auction in the systems of FIG. 1 and FIG. 2, or other bid invalidating auction systems. The steps of FIG. 5 are described as being performed by the service provider server 240. However, the steps may be performed by the processor of the service provider server 240, or by any other hardware component of the service provider server 240. Alternatively the steps may be performed by an external hardware component.

At step 510, the service provider server 240 identifies an item to be auctioned. For example, the administrator 110 may provide an identification of items to be auctioned to the service provider server 240. Alternatively, the service provider server 240 may receive a data feed listing items to be auctioned, such as from a third party server. At step 520, the service provider server 240 may provide elements characterized by an ordering, or a representation of the elements, to the users 120A-N. The ordering may identify the order in which the elements will be rendered ineligible over the course of the auction and may be provided to the users 120A-N such that the users 120A-N can develop element selection strategies for winning the auction. In one embodiment, a bid value of each element may be based on the order of the element in the ordering. For example, the next element to be rendered ineligible may have the highest bid value while the last element to be rendered ineligible may have the lowest bid value. In another embodiment, each element may be associated with a bid value for the item. A representation of the elements may be depicted on a user interface provided to the users 120A-N such as the user interfaces shown and discussed in FIGS. 7-8 below.

At step 530, the service provider server 240 receives a selection of an element from one of the users 120A-N, such as the user A 120A. At step 540, the service provider server 240 associates the selected element with the user A 120A if the element is not associated with any other users 120B-N and the element is eligible. The service provider server 240 may store one or more data records in the data store 245 which represent the association between the user A 120A and the element. The service provider server 240 may charge the cost per bid for the item to the user A 120A if the element is associated with the user A 120A.

At step 550, the service provider server 240 renders ineligible at least one element in accordance with the ordering. Ineligible elements are not eligible to win the auction and ineligible elements cannot be selected by the users 120A-N. In one embodiment, the service provider server 240 may render ineligible the eligible element having the highest bid value, regardless of whether the element was previously selected by one of the users 120A-N. Alternatively, the eligible element having the lowest bid value may be rendered ineligible, or more than one, or less than one, element may be rendered ineligible for each element selected.

At step 560, the service provider server 240 determines whether there are any elements which are not associated with one of the users 120A-N or are not ineligible. If, at step 560, the service provider server 240 determines there are available elements, the service provider server 240 returns to step 530. If, at step 560, the service provider server 240 determines there are no available elements, the service provider server 240 moves to step 570. At step 570, the service provider server 240 designates the user associated with the eligible user selected element which would, but for the end of the auction, eventually be rendered ineligible prior to any other eligible user selected element, the winner. The winning user A 120A may be rewarded with the option of purchasing the item for the value of the winning element, or some other discounted price. Alternatively, the user A 120A may be required to purchase the item for the value of the winning element.

FIG. 6 is a flowchart illustrating the operations of a time limited bid invalidating auction in the systems of FIG. 1 and FIG. 2, or other bid invalidating auction systems. The steps of FIG. 6 are described as being performed by the service provider server 240. However, the steps may be performed by the processor of the service provider server 240, or by any other hardware component of the service provider server 240. Alternatively the steps may be performed by an external hardware component.

At step 605, the service provider server 240 determines the maximum bid and minimum bid values for an item to be auctioned. The minimum bid value may often be zero and the maximum bid value may often be significantly less than the market price for the item. At step 610, the service provider server 240 determines the bid increment for the item to be auctioned. The bid increment may often be a small value, such as one cent or one penny. The minimum bid value, the maximum bid value and the bid increment can be used to define all of the bid values for the item. The bid values will be each value from the minimum bid value to the maximum bid value in increments of the bid increment. The service provider server 240 may also determine a cost per bid for the auction of the item. The cost per bid may refer to a fee the users 120A-N are charged for placing a bid in the auction. The fee may be calculated based on the minimum bid value, the maximum bid value and the bid increment such no single users A 120A, or group of collaborating users 120A-N, can guarantee a win of the auction at a collective cost below the MSRP of the item.

At step 615, the service provider server 240 provides elements characterized by an ordering, or representations thereof, to the users 120A-N. There may be an element representing each bid value for the item, and the elements may be ordered in accordance with the bid values. The elements may be provided to the users 120A-N through an interface, such as the user interfaces shown in FIGS. 7-8 below. At step 620, the service provider server 240 sets, and starts, a countdown timer for the auction. The countdown timer indicates the amount of time remaining in the auction. The countdown timer may add urgency to the auction and may ensure that the auction does not continue indefinitely if the elements are not fully selected by the users 120A-N.

At step 625, the service provider server 240 determines whether the countdown timer has expired. If, at step 625, the service provider server 240 determines that the countdown timer has expired, the service provider server 240 moves to step 675. At step 675, the service provider server 240 designates the user associated with the eligible selected element having the highest bid value the winner of the auction. If, at step 625, the service provider server 240 determines that the countdown timer has not expired, the service provider server 240 moves to step 630.

At step 630, the service provider server 240 determines whether one of the users 120A-N selected an element. If, at step 630, the service provider server 240 determines that one of the users 120A-N has not selected an element, the service provider server 240 returns to step 625. If, at step 630, the service provider server 240 determines that one of the users 120A-N, such as the user A 120A, has selected an element, the service provider server 240 moves to step 635. At step 635, the service provider server 240 verifies that the selected element is eligible and that the selected element is not associated with any of the users 120A-N. An element is considered eligible if the element has not been rendered ineligible. If, at step 635, the service provider server 240 determines the selected element is ineligible or is already associated with one of the users 120A-N, the service provider server 240 returns to step 625.

If, at step 635, the service provider server 240 determines that the element is eligible and is not associated with any of the users 120A-N, the service provider server 240 moves to step 640. At step 640, the service provider server 240 determines whether the selected element is one increment lower than the maximum bid value. The users 120A-N may not be allowed to select an element one increment lower than the maximum bid value because the element would be immediately render ineligible. If, at step 640, the service provider server 240 determines that the selected element is one increment lower than the maximum bid value, the service provider server 240 returns to step 625. If, at step 640, the service provider server 240 determines that the selected element is not one increment lower than the maximum bid value, the service provider server 240 moves to step 645.

At step 645, the service provider server 240 associates the user A 120A with the selected element, such as by storing one or more data records in the data store 245. The service provider server 240 may also charge the cost per bid to the user A 120A for selecting the element. At step 650, the service provider server 240 decreases the maximum bid value by a factor of the bid increment, such as one times the bid increment, one half of the bid increment, two times the bid increment, etc. At step 655, the service provider server 240 renders ineligible any elements having a higher bid value than the decreased maximum bid value.

At step 660, the service provider server 240 determines whether the countdown timer is below the end of auction threshold. The end of auction threshold may be an amount of time, such as fifteen seconds, which indicates that the end of the auction is approaching. If the countdown timer is below the end of auction threshold, such as if the countdown timer is less than fifteen seconds, the service provider server 240 moves to step 665. At step 665, the service provider server 240 adds time to the countdown timer. The amount of time added to the countdown timer may be a small amount, such as five seconds or fifteen seconds. If multiple users 120A-N simultaneously place bids within fifteen seconds of the auction closing, the amount of time is only added to the countdown timer once. Alternatively, the service provider server 240 may add a small amount of time, such as five seconds, each time an element is selected by one of the users 120A-N within the end of auction threshold. However, there may be a maximum end of auction time allowed for the countdown timer such that the countdown timer never exceeds the maximum end of auction time regardless of the number of elements selected. Alternatively, a small amount of time, such as five seconds, may be added to the countdown timer each time one of the users 120A-N selects an element regardless of the amount of time remaining in the auction. Alternatively, the amount of time added to after each bid may be based on the number of elements remaining. For example, if there are many elements still available, only one second may be added to the countdown timer after each bid, but if there are only a few elements still available, ten seconds may be added to the countdown timer after each bid.

The service provider server 240 may also implement other controls to prevent users 120A-N from placing several bids at the end of the auction. For example, within a short duration prior to the end of the auction, such as five minutes, the users 120A-N may not be allowed to exceed the number of bids they have placed thus far in the auction. Alternatively, within a short duration prior to the end of the auction, such as five minutes, the cost of placing a bid may increase as the amount of time remaining in the auction decreases. The service provider server 240 may also automatically render elements ineligible after a determined duration from the start of the auction, or based on some other trigger condition, such as the number of elements selected. Alternatively, the elements may automatically be rendered ineligible after a determined time interval elapses from the start of the auction with the condition that the automatic rendering is stopped when a user A 120A places a bid. Lastly, the service provider server 240 may reduce the ability of the users 120A-N to place bids as the auction end approaches, such as by capping the rate of bidding of each of the users 120A-N or capping the number of bids each of the users 120A-N can place.

If, at step 660, the service provider server 240 determines that the countdown timer is not below the end of auction threshold, the service provider server 240 moves to step 670. At step 670, the service provider server 240 determines whether there are any unselected eligible elements remaining. If, at step 670, the service provider server 240 determines there are eligible unselected elements remaining, the service provider server 240 returns to step 625.

If, at step 670, the service provider server 240 determines there are no eligible unselected elements remaining, the service provider server 240 moves to step 675. At step 675, the service provider server 240 designates the user associated with the eligible user selected element which would, but for the end of the auction, eventually be rendered ineligible prior to any other eligible user selected element, as the winner. The user designated as the winner is allowed to purchase the item being auctioned for the winning bid value, or some other discounted value. Alternatively, the winning user may be required to purchase the item for the bid value associated with the winning element, or some other discounted value.

FIG. 7 is a screenshot of an interface 700 for participating in a bid invalidating auction at the start of the auction in the systems of FIG. 1 and FIG. 2, or other bid invalidating auction systems. The interface 700 includes blocks 710, a scrollbar 713, an MSRP 720, an item picture 730, an item description 740, a current highest eligible bid value 750, a current highest bidder 755, a countdown timer 760, a cost per bid 770, and a savings summary 780. The blocks 710 include a lowest block 711 and a highest block 712.

In the interface 700, the ordering of the blocks 710 is based on a bid value represented by the blocks 710. Each block 710 displays the bid value represented by the block 710. In one embodiment, each block 710 may display the cost per bid for selecting each block 710. The cost per bid per block 710 may vary for each of the users 120A-N depending on the blocks 710 selected by each of the users 120A-N. Thus, the user interface 700 may display different costs per bid for each of the blocks 710 and/or for each of the users 120A-N.

The lowest block 711 is displayed in the lower left hand corner of the blocks 710 if all of the blocks 710 fit within the viewable portion of the interface 700 or when the scrollbar 713 is scrolled to the bottom of the blocks 710. The highest block 712 is displayed in the upper right hand corner of the blocks 710 if all of the blocks 710 fit within the viewable portion of the interface 700 or when the scrollbar 713 is scrolled to the top of the blocks 710. The scrollbar 713 can be used to access all of the blocks 710 if the blocks 710 do not all fit on viewable portion of the user interface 700. The blocks 710 are colored to indicate the state of the blocks 710. For example, a block 710 may be colored green to indicate a eligible block which is not associated with any of the users 120A-N.

The user interface 700 displays a picture 730 of the item being auctioned, a description 740 of the item being auctioned, and the MSRP 720 of the item, or the manufacturer's suggested retail price of the item. Alternatively, the user interface 700 may display the current market price of the item and may include links to an online store to purchase the item for the current market price. The user interface 700 further displays the current highest eligible bid value 750, the current highest bidder 755, the cost per bid 770, the countdown timer 760 and the savings summary 780. The savings summary 780 displays the amount of money which would be saved by the user viewing the interface 700 if the user wins the auction at their current highest bid. The amount of money which would be saved by the user is determined based on the MSRP 720 of the item, the cost of the bids placed by the user, and the current highest eligible bid of the user. The cost of the bids placed by the user and the current highest bid of the user are subtracted from the market price 720 of the item to determine the amount of money the user would save.

In operation, one of the users 120A-N, such as the user A 120A, can select one or more blocks 710 by clicking on the one or more blocks 710, such as with a computer pointing device. For example, the user A 120A may select one or more blocks having bid values coinciding with the amount of money the user A 120A is willing to pay for the item. Once the user A 120A selects a block, no other users 120B-N may select the block. The service provider server 240 may charge an account of the user A 120A the cost per bid 770 for each block selected by the user A 120A.

After the user A 120A selects a block 710, the service provider server 240 renders ineligible at least one of the blocks in accordance with the ordering of the blocks 710. For example, after the user A 120A selects a block 710, the service provider server 240 may render ineligible the highest eligible block remaining. Alternatively, the service provider server 240 may render ineligible the lowest eligible block remaining. Generally the service provider server 240 may render ineligible any order of blocks 710. The service provider server 240 may also render ineligible more than one, or less than one block for each block selected. For example, the service provider server 240 may render ineligible two blocks for every one block selected by the users 120A-N. Alternatively, the service provider server 240 may render ineligible one block for every two blocks selected by the users 120A-N. The service provider server 240 may also render ineligible blocks based on an event other than the selection of a block 710, such as a time interval elapsing.

In the user interface 700, each block 710 represents a bid increment of ten cents, or $0.10. The blocks 710 may represent a value band representing all the possible bids within the bid increment. For example, the block representing ten cents may include all of the bids from one cent up to ten cents.

FIG. 8 is a screenshot of an interface 800 for participating in a bid invalidating auction where an auction is in progress in the systems of FIG. 1 and FIG. 2, or other bid invalidating auction systems. The interface 800 includes blocks 710, a scrollbar 713, a market price 720, an item picture 730, an item description 740, a current highest eligible bid value 750, a current highest bidder 755, a countdown timer 760, a cost per bid 770, and a savings summary 780. The blocks 710 include available blocks 812, blocks owned by the current user 814, blocks owned by other users 816, and ineligible blocks 818.

In the interface 800, the ordering of the blocks 710 is based on a bid value represented by the blocks 710. Each block 710 displays the bid value represented by the block 710. The available blocks 812 represent blocks which have not been selected by any of the users 120A-N, and have not been rendered ineligible, thereby making the blocks 812 available for selection by the users 120A-N. The available blocks 812 are colored or shaded to differentiate the available blocks 812 from the other blocks. For example, the available blocks 812 may be colored green. The blocks owned by the current user 814 represent eligible blocks which were selected by the user viewing the user interface 800. The blocks owned by the current user 814 are colored or shaded to differentiate the blocks 814 from the other blocks. For example, the blocks owned by the current user 814 may be colored purple.

The blocks owned by other users 816 represents eligible blocks which have been selected by users other than the user viewing the user interface 800. The blocks owned by other users 816 are colored or shaded to differentiate the blocks owned by other users 816 from the other blocks. For example, the blocks owned by other users 816 may be colored grey. The ineligible blocks 818 represent blocks which have been rendered ineligible by the service provider server 240. The ineligible blocks 818 are colored or shaded to differentiate the ineligible blocks 818 from the other blocks. For example, the ineligible blocks 818 may be colored red.

In operation, one of the users 120A-N, such as the user A 120A, may use the interface 800 to participate in the bid invalidating auction for the item displayed in the item picture 730 and described in the item description 740. Each time one of the users 120A-N places a bid for the item, such as by selecting a block, the service provider server 240 may render ineligible at least one other eligible block in accordance with the ordering. For example, the service provider server 240 may render ineligible the eligible block having the highest bid value. In this example, the available block 812 with a value of “$18.40” would be rendered ineligible after the next bid is placed. The block is rendered ineligible irrespective of whether the block was previously selected by one of the users 120A-N. An ineligible block is no longer eligible to win the auction and can no longer be selected by the users 120A-N. All of the blocks are considered eligible, and can be rendered ineligible, except for the blocks which have already been rendered ineligible.

The user A 120A can place a bid by selecting any of the available blocks 812. However, if the highest eligible block is an available block 812, the user A 120A may be prevented from selecting the available block 812, because the available block would be immediately be rendered ineligible. The auction continues until either no available blocks 812 remain, or until the countdown timer 760 reaches zero. When the auction ends, the user associated with the eligible user selected element which would, but for the end of the auction, eventually be rendered ineligible prior to any other eligible user selected element, is designated the winner. In one embodiment, the user who selected the highest eligible block at the end of the auction is the winner. For example, in the interface 800 the current highest eligible bid value 750 is “$14.30” owned by the current highest bidder 755 named “Jeremy.” Thus, if the auction were to end, Jeremy would be designated the winner and could purchase the item for $14.30. The block displaying “$14.30” flashes in the interface 800 to identify the block associated with the current highest bid value, or generally to identify the user selected block which is next to be rendered ineligible.

The users 120A-N can configure the interface 800 to activate a sound signaling system which notifies the users 120A-N of an impending auction win, auction defeat, or other event of interest to the users 120A-N. The sound signaling system alleviates the need for the users 120A-N to watch the countdown timer 760 and allows the users 120A-N to focus on strategy in the waning moments of the auction. For example, the sound signaling system may increase the frequency of playing a sound as the auction approaches completion.

Due to delays in transferring data to and from the service provider server 240, a situation may arise where a user A 120A attempts to select a block which was just selected by another user B 120B. Thus, when a user A 120A selects a block, the user interface 800 may display an intermediate message, such as “checking” until the service provider server 240 confirms the user A 120A can be associated with the selected block. Alternatively, the user interface 800 may enter an altered display state, such as by displaying visual effects, until the service provider server 240 confirms the user A 120A can be associated with the selected block. The service provider server 240 processes selections from the users 120A-N on a first come first serve basis. For example, the service provider 240 may utilize a queue to store requests from the users 120A-N as they are received and then process the requests on a first come first serve basis.

The user interface 800 may also include a button which allows a user A 120A to automatically select the lowest available block 812 which would make the user A 120A the current highest bidder 755. The user interface 800 may also be controlled using a keyboard. The user interface 800 may constrain movement of a computer pointing device, such as a mouse, in order to allow for efficient selection of blocks in a single row and/or column.

FIG. 9 illustrates a general computer system 900, which may represent a service provider server 240, the computing devices 220A-N, the computing device 210, or any of the other computing devices referenced herein. The computer system 900 may include a set of instructions 924 that may be executed to cause the computer system 900 to perform any one or more of the methods or computer based functions disclosed herein. The computer system 900 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 924 (sequential or otherwise) that specify actions to be taken by that machine. In a particular embodiment, the computer system 900 may be implemented using electronic devices that provide voice, video or data communication. Further, while a single computer system 900 may be illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, such as, a central processing unit (CPU), a graphics processing unit (GPU), or both. The processor 902 may be a component in a variety of systems. For example, the processor 902 may be part of a standard personal computer or a workstation. The processor 902 may be one or more general processors, digital signal processors, application specific integrated circuits, field programmable gate arrays, servers, networks, digital circuits, analog circuits, combinations thereof, or other now known or later developed devices for analyzing and processing data. The processor 902 may implement a software program, such as code generated manually (i.e., programmed).

The computer system 900 may include a memory 904 that can communicate via a bus 908. The memory 904 may be a main memory, a static memory, or a dynamic memory. The memory 904 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 904 may include a cache or random access memory for the processor 902. Alternatively or in addition, the memory 904 may be separate from the processor 902, such as a cache memory of a processor, the system memory, or other memory. The memory 904 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 904 may be operable to store instructions 924 executable by the processor 902. The functions, acts or tasks illustrated in the figures or described herein may be performed by the programmed processor 902 executing the instructions 924 stored in the memory 904. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 900 may further include a display 914, such as a liquid crystal display (LCD), an organic light emitting diode (OLED), a flat panel display, a solid state display, a cathode ray tube (CRT), a projector, a printer or other now known or later developed display device for outputting determined information. The display 914 may act as an interface for the user to see the functioning of the processor 902, or specifically as an interface with the software stored in the memory 904 or in the drive unit 906.

Additionally, the computer system 900 may include an input device 912 configured to allow a user to interact with any of the components of system 900. The input device 912 may be a number pad, a keyboard, or a cursor control device, such as a mouse, or a joystick, touch screen display, remote control or any other device operative to interact with the system 900.

The computer system 900 may also include a disk or optical drive unit 906. The disk drive unit 906 may include a computer-readable medium 922 in which one or more sets of instructions 924, e.g. software, can be embedded. Further, the instructions 924 may perform one or more of the methods or logic as described herein. The instructions 924 may reside completely, or at least partially, within the memory 904 and/or within the processor 902 during execution by the computer system 900. The memory 904 and the processor 902 also may include computer-readable media as discussed above.

The present disclosure contemplates a computer-readable medium 922 that includes instructions 924 or receives and executes instructions 924 responsive to a propagated signal; so that a device connected to a network 235 may communicate voice, video, audio, images or any other data over the network 235. Further, the instructions 924 may be transmitted or received over the network 235 via a communication interface 918. The communication interface 918 may be a part of the processor 902 or may be a separate component. The communication interface 918 may be created in software or may be a physical connection in hardware. The communication interface 918 may be configured to connect with a network 235, external media, the display 914, or any other components in system 900, or combinations thereof. The connection with the network 235 may be a physical connection, such as a wired Ethernet connection or may be established wirelessly as discussed below. Likewise, the additional connections with other components of the system 900 may be physical connections or may be established wirelessly. In the case of a service provider server 240, the service provider server 240 may communicate with users 120A-N through the communication interface 918.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 922 may be a single medium, or the computer-readable medium 922 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 922 may include a solid-state memory such as a memory card or other package that houses one or more non-volatile read-only memories. The computer-readable medium 922 also may be a random access memory or other volatile re-writable memory. Additionally, the computer-readable medium 922 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method of determining a winner of a contest, the method comprising:
(a) providing a plurality of elements to a plurality of users, wherein the plurality of elements are characterized by an ordering by which the elements will be rendered ineligible to win a contest, each element being initially eligible to win the contest and each element being initially unassociated with any of the plurality of users;
(b) receiving a selection of a first element of the plurality of elements from a first user;
(c) associating the first element with the first user if the first element is not associated with another user and the first element is eligible to win the contest;
(d) identifying a second element of the plurality of elements, the second element being eligible to win the contest, wherein, in accordance with the ordering, the second element would be rendered ineligible prior to any other element eligible to win the contest;
(e) rendering the second element ineligible to win the contest, if the first element is associated with the first user;
(f) repeating, by a processor, steps (b)-(e), until an occurrence of an event;
(g) identifying, upon the occurrence of the event, a third element of the plurality of elements, the third element being eligible to win the contest and associated with a second user, wherein, in accordance with the ordering, the third element would, but for the occurrence of the event, eventually be rendered ineligible to win the contest prior to any other eligible element associated with one of the plurality of users; and
(h) designating the second user a winner of the contest.

2. The method of claim 1 wherein the event comprises all of the elements being either associated with one of the users or rendered ineligible to win the contest.

3. The method of claim 1 further comprising:
(i) charging the first user a fee, if the first user is associated with the first element.

4. The method of claim 1 wherein rendering the second element ineligible to win the contest, if the first element is associated with the first user comprises:
identifying a fourth element of the plurality of elements, the fourth element being ineligible to win the contest, wherein, in accordance with the ordering, the fourth element was rendered ineligible to win the contest after all other elements which are ineligible to win the contest; and
rendering the second element ineligible to win the contest, if the first element is associated with the user and if at least one other element was associated with one of the users since the fourth element was rendered ineligible to win the contest.

5. The method of claim 1 further comprising:
(j) repeating steps (d)-(e) a number of times in order to render the number of elements ineligible to win the contest, if the first element is associated with the first user.

6. The method of claim 1 wherein the plurality of elements comprise a plurality of blocks.

7. The method of claim 6 further comprising displaying a representation of the plurality of blocks to the first user, wherein the blocks which are not associated with one of the users and are eligible to win the contest are indicated.

8. The method of claim 7 further comprising modifying a graphical attribute of each block based on whether each block is associated with one of the users or is ineligible to win the contest.

9. The method of claim 8 wherein the graphical attribute comprises a color of each block.

10. The method of claim 1 wherein the ordering comprises a linear ordering.

11. The method of claim 1 wherein each element of the plurality of elements is associated with a unique bid value and the ordering by which the elements will be rendered ineligible to win the contest is based on the bid values.

12. The method of claim 1 wherein the contest comprises an auction for an item and the winner of the contest is sold the item for a price below the manufacturer's suggested retail price of the item.

13. The method of claim 12 further comprising:
determining a minimum bid value, a maximum bid value and a bid increment for the item; and
associating the plurality of available elements with a plurality of unique bid values, wherein the plurality of unique bid values range from the minimum bid value to the maximum bid value increasing in increments of the bid increment.

14. The method of claim 13 further comprising determining a cost per bid based on the minimum bid value, the maximum bid value, and the bid increment.

15. The method of claim 14 further comprising:
(k) charging the first user the cost per bid, if the first user is associated with the first element.

16. The method of claim 15 further comprising:
(l) receiving a payment of an amount of the bid value associated with the third element from the second user; and
(m) providing the item to the second user.

17. The method of claim 1 further comprising:
(n) setting a countdown timer to countdown for a determined time interval; and
(o) starting the countdown timer when the plurality of available elements are provided to the plurality of users.

18. The method of claim 17 wherein the event comprises the countdown timer expiring.

19. The method of claim 18 further comprising adding an extra time interval to the countdown timer upon rendering the second element ineligible to win the contest.

20. The method of claim 19 wherein the extra time interval is added to the countdown timer if the countdown timer has less than an amount of time remaining.

21. The method of claim 1 further comprising:
(p) providing an indication of the ordering to the plurality of users.

22. A method of playing a game, the method comprising:
(a) providing a plurality of blocks to a plurality of users for playing a game, wherein the plurality of blocks are characterized by an ordering by which the blocks will be removed from the game;
(b) receiving a selection of a block of the plurality of blocks from a first user of the plurality of users;
(c) associating the selected block with the first user;
(d) removing a factor of the plurality of blocks from the game in accordance with the ordering;
(e) repeating steps (b)-(d), until an occurrence of an event;
(f) awarding, upon the occurrence of the event, a second user, the second user being associated with a next selected block to be removed from the game in accordance with the ordering.

23. The method of claim 22 wherein the event comprises all of the blocks being either associated with one of the users or removed from the game.

24. The method of claim 22 wherein the ordering comprises a linear ordering.

25. The method of claim 24 wherein each block of the plurality of blocks is associated with a unique value and the ordering of the plurality of blocks is based on the unique values.

26. The method of claim 22 further comprising:
(g) charging the first user a fee upon associating the selected block with the first user.

27. A method of auctioning an item, the method comprising:
(a) determining a maximum bid value, a minimum bid value, and a bid increment of an item for an auction;
(b) providing an indication of the item to be auctioned and a plurality of elements to the plurality of users, each element being associated with a unique bid value ranging from the minimum bid value to the maximum bid value in increments of the bid increment, wherein the elements are characterized by an ordering based on the bid value, each element being initially eligible to win the auction and each element being initially unassociated with any of the plurality of users;
(c) receiving a selection of a first element from a first user;
(d) associating the first element with the first user, if the first element is not associated with another user;
(e) decreasing the maximum bid value by a factor, if the first element is associated with the first user;
(f) rendering any elements which are associated with a bid value greater than the maximum bid value ineligible to win the auction;
(g) repeating, by a processor, steps (c)-(f) until each element of the plurality of available elements is either associated with a user or rendered ineligible to win the auction; and
(i) designating the user associated with the element having a highest bid value which is not rendered ineligible a winner of the auction.

28. The method of claim 27 wherein the factor comprises the bid increment.

29. A method of determining a winner of a contest, the method comprising:
(a) providing a plurality of elements to a plurality of users, wherein the plurality of elements are characterized by an ordering by which the elements will be rendered ineligible to win a contest, each of the plurality of elements being initially unassociated with any of the plurality of users and further characterized by a status initially indicative of each element being eligible to win the contest;
(b) receiving a selection of a first element of the plurality of elements from a first user of the plurality of users;
(c) associating the first element with the first user if the first element is not associated with another user and the status of the first element is indicative of the first element being eligible to win the contest;
(d) identifying a second element of the plurality of elements, the second element having a status indicative of being eligible to win the contest, wherein, in accordance with the ordering, the second element would be rendered ineligible to win the contest prior to any other element having a status indicative of being eligible to win the contest;
(e) changing the status of the second element to indicate that the second element is ineligible to win the contest, if the first element is associated with the first user;
(f) repeating steps (b)-(e), by a processor, until an occurrence of an event;
(g) identifying a third element of the plurality of elements, the third element being associated with a second user of the plurality of users and having a status indicative of the third element being eligible to win the contest, wherein, in accordance with the ordering, the third element would, but for the occurrence of the event, eventually be rendered ineligible to win the contest prior to any other element associated with a user and having a status indicative of being eligible; and
(h) designating the second user a winner of the contest.

30. A method of determining a winner of a contest, the method comprising:
(a) providing a plurality of elements to a plurality of users, wherein the plurality of elements are characterized by an ordering by which the elements will be rendered ineligible to win a contest, each element being initially eligible to win the contest and each element being initially unassociated with any of the plurality of users;
(b) receiving a selection of a first element of the plurality of elements from a first user;
(c) associating the first element with the first user if the first element is not associated with another user and the first element is at least partially eligible to win the contest;
(d) identifying a second element of the plurality of elements, the second element being at least partially eligible to win the contest, wherein, in accordance with the ordering, the second element would be rendered ineligible prior to any other element at least partially eligible to win the contest;
(e) rendering the second element at least partially ineligible to win the contest, if the first element is associated with the first user;
(f) repeating steps (b)-(e), by a processor, until an occurrence of an event;
(g) identifying, upon the occurrence of the event, a third element of the plurality of elements, the third element being at least partially eligible to win the contest and associated with a second user, wherein, in accordance with the ordering, the third element would, but for the occurrence of the event, eventually be rendered ineligible to win the contest prior to any other at least partially eligible element associated with one of the plurality of users; and
(h) designating the second user a winner of the contest.

31. The method of claim 1 further comprising:
(i) repeating steps (d)-(e) a number of times in order to render the number of elements at least partially ineligible to win the contest, if the first element is associated with the first user.

32. A method of determining a winner of a contest, the method comprising:
(a) providing, by a processor, a plurality of elements to a plurality of users, wherein the plurality of elements are characterized by an ordering, each element being further characterized by a first and second status, the first status of each element initially indicative of each item being available for selection, the second status of each element initially indicative of each item being eligible to win the contest;
(b) receiving, by the processor, a selection of an element of the plurality of elements from a first user of the plurality of users;
(c) determining, by the processor, whether the first status of the selected element is indicative of the selected element being available and the second status of the selected element is indicative of the second element being eligible and, where the first status of the selected element is indicative of the selected element being available and the second status of the selected element is indicative of the selected element being eligible, associating, by the processor, the selected element with the first user and changing, by the processor, the first status of the selected element to indicate that the selected element is unavailable, and, where the first status of the selected element is indicative of the selected element being unavailable or the second status of the selected element is indicative of the selected element being ineligible, providing, by the processor, the first user with the status of the item;
(d) identifying, by the processor, a first element of the plurality of elements, in accordance with the ordering, wherein second status of the first element indicates that the element is eligible, and changing the second status of the first element to indicate that the element is ineligible, if the selected element is associated with the first user;
(e) providing an update of any rendered statuses of the plurality of elements to the plurality of users;
(f) repeating, by the processor, the receiving, determining, associating, providing, identifying and changing, until the occurrence of an event;
(g) determining, upon occurrence of the event, a second element of the plurality of elements the first status of which indicates that the second element is unavailable and the second status of which indicates that the second element is eligible and which, if not for the occurrence of the event, eventually would have been identified by the identifying, in accordance with the ordering, as the first element prior to any other of the plurality of elements whose first status is indicative of the other element being unavailable and whose second status is indicative of the other element being eligible; and
(h) designating the user of the plurality of users associated with the second element a winner of the contest.

33. A system for determining a winner of a contest, the system comprising:
a memory operative to store a plurality of elements, wherein the plurality of elements are characterized by an ordering by which the elements will be rendered ineligible to win a contest, each element being initially eligible to win the contest and each element being initially unassociated with any of a plurality of users;
an interface coupled with the memory and operative to provide the plurality of elements to a plurality of users, and to receive a selection of a first element of the plurality of elements from a first user of the plurality of users; and
a processor coupled with the interface and operative to provide, via the interface, the plurality of elements to the plurality of users, receive, via the interface, the selection of the first element of the plurality of elements from the first user, associate the first element with the first user if the first element is not associated with another user and the first element is eligible to win the contest, identify a second element of the plurality of elements, the second element being eligible to win the contest, wherein, in accordance with the ordering, the second element would be rendered ineligible prior to any other element eligible to win the contest, render the second element ineligible to win the contest, if the first element is associated with the first user, repeat the receive, associate, identify and render until an occurrence of an event, identify, upon the occurrence of the event, a third element of the plurality of elements, the third element being eligible to win the contest and associated with a second user, wherein, in accordance with the ordering, the third element would, but for the occurrence of the event, eventually be rendered ineligible to win the contest prior to any other eligible element associated with one of the plurality of users, and designate the second user a winner of the auction.

34. The system of claim 33 further comprising:
the processor further operative to charge the first user if the first user is associated with the first element.

35. The system of claim 33 wherein the event comprises all of the elements being either associated with one of the users or rendered ineligible to win the contest.

36. The system of claim 33 further comprising:
the processor further operative to identify a fourth element of the plurality of elements, the fourth element being ineligible to win the contest, wherein, in accordance with the ordering, the fourth element was rendered ineligible to win the contest after all other elements which are ineligible to win the contest, and render the second element ineligible to win the contest, if the first element is associated with the user and if at least one other element was associated with one of the users since the fourth element was rendered ineligible to win the contest.

37. The system of claim 33 further comprising:
the processor further operative to repeat the identify and the render a number of times in order to render the number of elements ineligible to win the contest, if the first element is associated with the first user.

38. The system of claim 33 wherein each element of the plurality of elements is associated with a unique bid value and the ordering by which the elements will be rendered ineligible to win the contest is based on the bid values.

39. The system of claim 33 wherein the contest comprises an auction for an item and the winner of the contest is sold the item for a price below the manufacturer's suggested retail price of the item.

40. The system of claim 33 further comprising:
the processor further operative to determine a minimum bid value, a maximum bid value and a bid increment for the item, and associate the plurality of available elements with a plurality of unique bid values, wherein the plurality of unique bid values range from the minimum bid value to the maximum bid value increasing in increments of the bid increment.

41. The system of claim 40 further comprising:
the processor further operative to determine a cost per bid based on the minimum bid value, the maximum bid value, and the bid increment.

42. The system of claim 41 further comprising:
the processor further operative to charge the first user the cost per bid, if the first user is associated with the first element.

43. The system of claim 33 further comprising:
the interface further operative to provide an indication of the ordering to the plurality of users.
